(19) United States
(12) Patent Application Publication
(10) Pub. No.: US 2003/0119403 A1
(43) Pub. Date: Jun. 26, 2003

(54) Spunbond nonwoven fabric

(75) Inventors: Edward Keith Willis, Madison, TN (US); Edward L. Brignola, Old Hickory, TN (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Reemay, Inc.

(21) Appl. No.: 10/305,778

(22) Filed: Nov. 27, 2002

Related U.S. Application Data
(60) Provisional application No. 60/334,500, filed on Nov. 30, 2001.

(51) Int. Cl. B32B 31/00; B32B 1/00; D04H 3/16

(52) U.S. Cl. 442/337; 442/338; 442/361; 442/364; 442/401; 428/397; 428/398; 264/172.12; 264/172.15; 264/171.1; 156/166; 156/167

(57) ABSTRACT

A spunbond nonwoven fabric is provided, formed from a multiplicity of substantially continuous bicomponent filaments randomly arranged and bonded to one another. The bicomponent filaments have a multilobal cross-sectional configuration including a first polymer component formed of a higher-melting composition occupying at least the central portion of the filament cross-section and a second polymer component formed of a lower-melting composition being present in at least one lobe of the multilobal cross-section.

### CROSS-REFERENCE TO RELATED APPLICATION

This application claims priority from U.S. Provisional Application No. 60/334,500 filed Nov. 30, 2001.

### FIELD OF THE INVENTION

The invention relates to the manufacture of spunbond nonwoven fabrics.

### BACKGROUND OF THE INVENTION

A spunbond nonwoven fabric has been produced commercially for many years by Reemay, Inc. and sold under the registered trademark Reemay®. This spunbond fabric is produced generally in accordance with the teachings of U.S. Pat. Nos. 3,384,944 and 3,989,788. Separately extruded matrix filaments from a polyester homopolymer and binder filaments from a polyester copolymer are intermingled with one another and deposited onto a moving belt to form a web. The web of filaments is directed through a steam consolidator and then through a hot air bonder, where the binder filaments soften and melt to form bonds throughout the web, resulting in a nonwoven fabric with desirable physical properties.

When quality or process issues arise in the manufacturing process, the lower melting binder filaments are often implicated. For example, it is important for the binder filaments to be uniformly intermingled with the homopolymer matrix filaments in order to achieve optimal physical properties. Any variations in the distribution of the binder and matrix filaments or in their relative proportions can result in quality variations. After extended periods of operation of the manufacturing process, deposits of the binder filament composition can build up on the bonder, causing deterioration in product quality and requiring periodic downtime for cleaning of the bonder screens.

### SUMMARY OF THE INVENTION

These and other limitations and disadvantages of prior manufacturing processes are overcome in accordance with the present invention by producing a spunbond fabric wherein the lower-melting binder composition is integrated with the homopolymer matrix filament composition in a bicomponent filament. The present invention provides a spunbond nonwoven fabric which is formed from substantially continuous bicomponent filaments of a multilobal cross-sectional configuration containing both a higher-melting matrix component and a lower-melting binder component. By having the binder component attached to the homopolymer matrix component, several advantages are obtained. The matrix component serves to transport the binder component throughout the web formation, consolidation and bonding steps. Significant improvements both in processability and in product quality are observed. Surprisingly, the resulting spunbond nonwoven fabric has a superior combination of physical properties as compared to a comparable spunbond fabric made from separately extruded matrix filaments and binder filaments.

In general, the spunbond nonwoven fabrics of the present invention comprise a multiplicity of substantially continuous bicomponent filaments of a multilobal cross-sectional configuration randomly arranged and bonded to one another. The bicomponent filaments include a first polymer component formed of a homopolymer occupying at least the central portion of the filament cross section and a second polymer component formed of a lower-melting copolymer, with this second polymer component being present in at least one of the lobes of the multilobal filament.

In one specific embodiment of the present invention, the spunbond nonwoven fabric is formed by a multiplicity of randomly arranged substantially continuous bicomponent polyester filaments having a multilobal cross-sectional configuration. The bicomponent filaments include a first polymer component formed of polyethylene terephthalate homopolymer occupying at least the central portion of the filament cross-section and a second polymer component formed of a copolymer of polyethylene isophthalate and polyethylene terephthalate occupying the remainder of the cross-sectional area of the filament. Preferably, the copolymer comprises from about 2 to about 25 percent by weight of the filament, and more desirably up to about 10 percent by weight. The second polymer component creates a multiplicity of fusion bonds by the bonding with other filaments of the fabric at filament cross-over points. The fusion bonds are located uniformly throughout the area of the fabric. The nonwoven fabric can be formed entirely of the bicomponent filaments or can include a mixture of the bicomponent filaments with filaments formed entirely of the homopolyester.

### BRIEF DESCRIPTION OF THE DRAWINGS

Some of the features and advantages of the invention having been described, others will become apparent from the detailed description which follows, and from the accompanying drawings, in which:

FIG. 1 is a schematic illustration of an arrangement of apparatus for producing the nonwoven fabrics of the present invention.

FIG. 2 illustrates a multilobal filament cross-section which can be utilized in accordance with one embodiment of the invention;

FIG. 3 illustrates a trilobal filament cross-section which can be utilized in accordance with another embodiment of the invention;

FIG. 4 illustrates a hollow multilobal filament cross-section which can be utilized in accordance with another embodiment of the invention; and

FIG. 5 illustrates a hollow trilobal filament cross-section which can be utilized in accordance with another embodiment of the invention.

### DETAILED DESCRIPTION

Spunbond nonwoven fabrics in accordance with the present invention are produced by producing two separate molten streams of molten polymer: a first higher-melting fiber-forming polymer composition and a lower-melting second fiber-forming polymer composition. Various thermoplastic fiber-forming polymer compositions can be used in accordance with the broadest aspects of the present invention, such as polyesters, nylons, polyolefins. One specific preferred embodiment of the present invention utilizes two separate polyesters, a polyester homopolymer such as polyethylene terephthalate and a lower-melting polyester copolymer, such as a copolymer of polyethylene isophthalate and polyethylene terephthalate. The copolyester composition preferably comprises from 2 to 25, more desirably 5 to 20 percent, of the isophthalate. The homopolymer polyester and the copolymer polyester raw materials are typically supplied in flake form and are melted in separate extruders. The molten polymers are separately fed the to a spinneret designed for producing a bicomponent filament of the desired cross-sectional configuration. Suitable spinnerets are commercially available from various sources. One type of spinneret for forming bicomponent filaments is described in Hills U.S. Pat. No. 5,562,930.

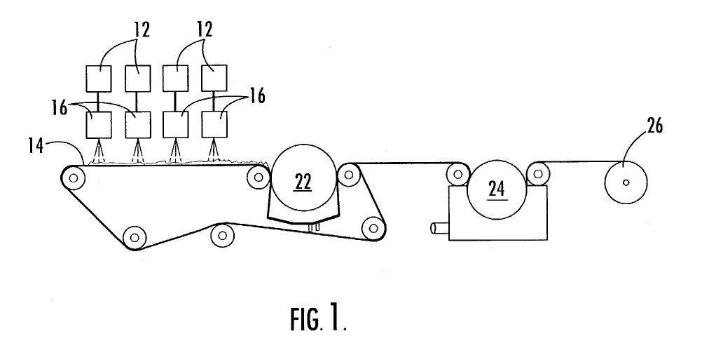

FIG. 1 schematically illustrates an arrangement of apparatus for producing a spunbond polyester nonwoven fabric in accordance with one embodiment of the present invention. The apparatus includes four spin beams 12 mounted above an endless moving conveyor belt 14. While the illustrated apparatus has four spin beams, it will be understood that other configurations of apparatus with one or more spin beams could be employed. Each beam extends widthwise in the cross-machine direction, and the respective beams are successively arranged in the machine direction. Each beam is supplied with molten polyester homopolymer and with molten polyester copolymer from respective extruders (not shown). Spinnerets with orifices configured for producing multilobal bicomponent filaments are mounted to each of the four spin beams 12. The molten polyester homopolymer is directed so as to form the central portion of the multilobal filaments, and the molten polyester copolymer is directed so as to be present at the tips of the lobes of the multilobal cross-section filaments. The spinnerets can be configured to form bicomponent filaments at all of the spinneret orifices, or alternatively, depending upon the particular product characteristics desired, the spinnerets can be configured to produce some bicomponent multilobal filament and some multilobal filament formed entirely of the polyester homopolymer matrix composition.

The freshly extruded filaments are cooled and solidified by contact with a flow of quench air, and the filaments are then attenuated and drawn, either mechanically or pneumatically by attenuator devices 16. The filaments are then deposited randomly onto the advancing belt 14 to form a web. This web of unbonded filaments is then directed through a steam consolidator 22, an example of which is generally shown in Estes et al. U.S. Pat. No. 3,989,788. The web is contacted with saturated steam, which serves to soften the copolyester binder component of the filaments. The web is then transferred to a hot air bonder 24. The temperatures used in the bonding operation are considerably higher than those used in consolidation, the temperature selected being dependent upon the properties desired in the product (i.e., strength, dimensional stability or stiffness). Typically the consolidated web is exposed to air at 140 to 250 degrees C. preferably 215 to 250 degrees C. during bonding. During the consolidation and bonding steps, the copolyester binder component of the filament softens, producing fusion bonds where the filaments across one another. The resulting nonwoven fabric is a “flat bonded” nonwoven, with bond sites uniformly distributed throughout the area and the thickness of the fabric. The bond sites provide the necessary sheet properties such as tear strength and tensile strength. The bonded web passes over exit roll to a windup device 26.

The bicomponent filaments used in the nonwoven fabrics of the present invention have a modified cross-section defining multiple lobes. It is important that the copolyester binder component be present on at least a portion of the surface of the filament, and desirably, the binder component should be located in at least one of the lobes of the multilobal filament cross section. Most preferably, the binder component is located at the tip of one or more of the lobes. The copolyester binder component should preferably comprise from about 2 to about 25 percent by weight of the filament.

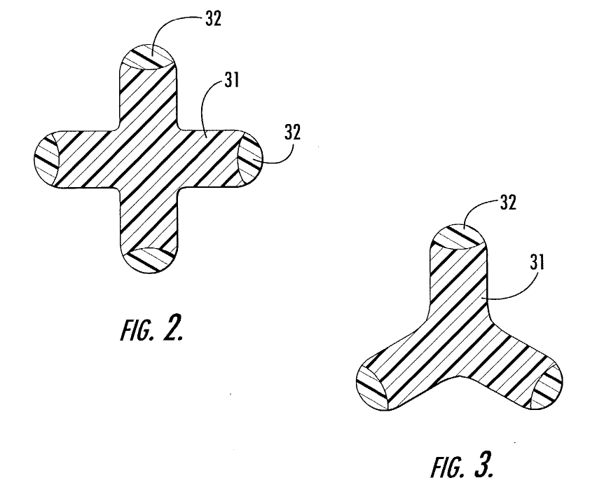

FIG. 2 illustrates a solid multilobal filament cross-section wherein the filament has four lobes. The homopolymer polyester matrix component 31 occupies the central portion of the filament cross-section, and the copolyester binder component 32 occupies the tip portion of each lobe. In an alternate embodiment, the copolyester binder component can occupy the tip portion of only a single lobe, or the tips of two or three of the lobes. FIG. 3 illustrates a solid trilobal filament cross-section wherein the copolyester binder component 32 occupies the tip portion of each lobe. In an alternate form, the copolyester binder component 32 can occupy only one or two of the three lobes.

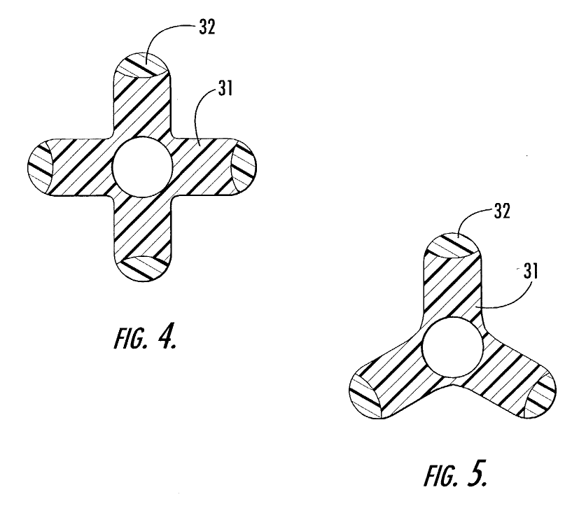

The filaments may also be produced with a hollow cross-section, using commercially available spinnerets configured for this purpose. FIG. 4 illustrates a hollow four-lobed filament cross-section wherein the homopolymer polyester component 31 occupies the central portion of the filament cross-section and the copolyester binder component 32 occupies the tip portion of each lobe. FIG. 5 illustrates a hollow trilobal filament cross-section wherein the copolyester binder component 32 occupies the tip portion of each lobe. The void area in the hollow filaments preferably comprises from 5 to 30 percent of the cross-sectional area of the filament.

Polyester spunbond nonwoven fabrics produced from bicomponent filaments of the type described herein have been found to exhibit surprisingly improved physical properties as compared to a comparable nonwoven fabric produced from separately formed matrix filaments and binder filaments. The fabric exhibits significantly increased tensile strength while maintaining the tear strength comparable to that of the conventional construction. With conventional polyester spunbond nonwovens formed from separate homopolyester matrix filaments and copolyester binder filaments, it is exceedingly difficult to increase the web tensile strength without adversely affecting the tear strength. Increasing the bonder temperature or increasing the amount of binder filaments to improve tensile strength typically results in an overbonded condition with consequent loss of tear strength. Surprisingly however, with the present invention it is possible to significantly increase the tensile strength without adversely affecting tear strength. With fabrics of the present invention, the ratio of the web tensile strength to web tear strength in the same web direction is 3 or greater, preferably 4 or greater, while the tear strength is at least 3 pounds per inch of web width. The production of fabrics in accordance with the invention has the further advantage of improved spinnability and lower thermal demand in the bonder. Since the binder component is supported by the homopolyester matrix component, effective bonding can be achieved without heating the binder component all the way to the melting point. This results in improved hand properties in the fabric.

### EXAMPLE

Tests were run to evaluate the properties of polyester spunbond nonwoven webs produced by the conventional cospun approach with separate homopolyester matrix filaments and copolyester binder filaments versus tipped multilobal bicomponent filaments. Webs were produced using a bicomponent spin pack configured to produce a trilobal cross-section filament of 90 weight percent homopolymer polyethylene terephthalate and 10 weight percent copolyester (polyethylene isophthalate). The copolyester was situated on one tip of the trilobal filament. Webs were produced with a filament size of 4 denier per filament and at web weights of 0.56, 0.75 and 1.0 ounces per square yard nominal basis weight. As controls, webs of comparable filament size and basis weight were produced with a conventional spin pack producing separate filaments of homopolyester matrix filaments (90 weight percent) and copolyester binder filaments (10 weight percent). Efforts were made to maintain consistent and repeatable processing conditions (e.g. extruder temperatures, draw ratio, bonder settings) on all runs. Samples of each web were submitted to laboratory analysis for physical properties. As seen from Table 1 below, the webs made from the tipped trilobal filaments showed a marked improvement in tensile strength without a reduction in tear strength, as compared to the comparable cospun control fabrics.

| | Cospun | Tipped | Cospun | Tipped | Cospun | Tipped |
|---|---|---|---|---|---|---|
| Style | control | Trilobal | control | Trilobal | control | Trilobal |
| Unit Weight | 0.68 | 0.56 | 0.81 | 0.72 | 1.00 | 1.00 |
| (oz/yd² | | | | | | |
| MD Grab | 5.9 | 12.9 | 11.8 | 25.2 | 12.6 | 31.0 |
| Tensile (lbs.) | | | | | | |
| MD | 3.4 | 3.2 | 4.4 | 5.3 | 5.9 | 6.4 |
| Trapezoidal | | | | | | |
| Tear (lbs) | | | | | | |
| Ratio MD | 1.74 | 4.03 | 2.68 | 4.75 | 2.14 | 4.84 |
| Tensile/ | | | | | | |
| MD Tear | | | | | | |

That which is claimed is:

1. A spunbond nonwoven fabric comprising a multiplicity of substantially continuous bicomponent filaments randomly arranged and bonded to one another, said bicomponent filaments having a multilobal cross-sectional configuration including a first polymer component formed of a higher-melting composition occupying at least the central portion of the filament cross-section and a second polymer component formed of a lower-melting composition being present in at least one lobe of the multilobal cross-section.

2. The nonwoven fabric of claim 1, wherein the ratio of the web tensile strength to web tear strength in the same web direction is 3 or greater.

3. The nonwoven fabric of claim 2, wherein the ratio of the web tensile strength to web tear strength in the same web direction is 4 or greater, while the tear strength is at least 3 pounds per inch of web width.

4. The nonwoven fabric of claim 1, wherein said first polymer component is a polyester homopolymer and second polymer component is a polyester copolymer.

5. The nonwoven fabric of claim 4, wherein said first polymer component is a polyethylene terephthalate homopolymer and second polymer component is a polyethylene isophthalate copolymer.

6. The nonwoven fabric of claim 1 wherein said second polymer component comprises no more than 25 percent by weight of the filament.

7. The nonwoven fabric of claim 1 wherein said filaments have a trilobal cross-sectional configuration and said second component is located at the tip of at least one lobe.

8. The nonwoven fabric of claim 1 wherein at least some of said multilobal filaments are hollow.

9. A spunbond nonwoven fabric comprising a multiplicity of substantially continuous bicomponent polyester filaments randomly arranged and bonded to one another, said bicomponent polyester filaments having a multilobal cross-sectional configuration including a first polymer component formed of a polyethylene terephthalate homopolymer occupying at least the central portion of the filament cross-section and a second polymer component formed of polyethylene isophthalate copolymer present at the tip of at least one lobe of the multilobal cross-section.

10. The nonwoven fabric of claim 9 wherein the second polymer component comprises no more than 25 percent of the cross-sectional area of the filament.

11. The nonwoven fabric of claim 9 wherein the bicomponent filaments have a trilobal cross-section and said second polymer component is present only at the tip of at least one lobe the of the trilobal filament.

12. The nonwoven fabric of claim 9 including a multiplicity of fusion bonds formed by said second polymer component bonding with other filaments of the fabric at filament cross over points, said fusion bonds being located uniformly throughout the area of the fabric.

13. The nonwoven fabric of claim 9 wherein at least some of said multilobal filaments are hollow.

14. A spunbond polyester nonwoven fabric formed by a multiplicity of randomly arranged substantially continuous bicomponent polyester filaments, the bicomponent filaments having a trilobal cross-section including a first polymer component formed of polyethylene terephthalate homopolymer occupying at least the central portion of the trilobal cross-section and a second polymer component formed of a copolymer of polyethylene isophthalate and polyethylene terephthalate occupying the tip portion of at least one of the lobes of the trilobal cross-section, and a multiplicity of fusion bonds formed by said second polymer component bonding with other filaments of the fabric at filament cross over points, said fusion bonds being located uniformly throughout the area of the fabric, and wherein the ratio of the web tensile strength to web tear strength in the same web direction is 3 or greater.

15. The nonwoven fabric of claim 14 wherein the second polymer component comprises no more than 10 percent by weight of the filament.

16. A method of making a spunbond nonwoven fabric comprising melt extruding a multiplicity of substantially continuous bicomponent filaments having a multilobal cross-sectional configuration including a first polymer component formed of a higher-melting composition occupying at least the central portion of the filament cross-section and a second polymer component formed of a lower-melting composition being present in at least one lobe of the multilobal cross-section, depositing the filaments on a collection surface to form a web, and bonding the filaments to form a bonded nonwoven web.

17. The method of claim 16 wherein said first polymer component is a polyester homopolymer and second polymer component is a polyester copolymer.

18. The method of claim 17 wherein said second polymer component comprises no more than 25 percent by weight of the filament.

19. The method of claim 16 wherein said extruding step comprises forming the filaments with a trilobal cross-sectional configuration in which said second component is located at the tip of at least one lobe.

20. The method of claim 16 wherein said step of bonding the filaments comprises heating the filaments to a temperature at which the lower-melting second polymer composition softens and becomes adhesive while the first polymer component remains solid, maintaining the filaments in the form of a web while the softened second polymer component adheres to portions of other filaments at filament crossover points, and cooling the filaments to solidify the second polymer composition and form a bonded nonwoven web.

21. A method of making a spunbonded nonwoven fabric comprising separately melting a first polymer component formed of a polyethylene terephthalate homopolymer and a second polymer component formed of polyethylene isophthalate copolymer, directing the first and second polymer components through spinneret orifices configured to form a multilobal cross-section filaments in which the first polymer component occupies at least the central portion of the filament cross-section and the second polymer component is present at the tip of at least one lobe of the multilobal cross-section, randomly depositing the filaments on an advancing collection surface to form a web, directing the web of randomly deposited filaments through a heated zone and heating the filaments to a temperature at which the lower-melting second polymer composition softens and becomes adhesive while the first polymer component remains solid, so that the softened second polymer component adheres to portions of other filaments at filament crossover points, and cooling the filaments to solidify the second polymer composition and form a bonded nonwoven web.

22. The method of claim 21 wherein the second polymer component is present at the tips of each of the lobes of the multilobal filaments.
